(19) United States
(12) Patent Application Publication
(10) Pub. No.: US 2016/0371706 A1
(43) Pub. Date: Dec. 22, 2016

(54) COMPUTERIZED SYSTEM AND METHOD FOR MEASURING AND ANALYZING PROVIDER UTILIZATION

(71) Applicant: HUMANA INC., (US)

(72) Inventors: Dean M. Fry, Crowley, TX (US); Stacie L. Thuma, Green Bay, WI (US)

(73) Assignee: HUMANA INC., Louisville, KY (US)

(21) Appl. No.: 13/715,114

(22) Filed: Dec. 14, 2012

(51) Int. Cl. G06Q 50/00; G06Q 50/22

(52) U.S. Cl. CPC G06Q 30/0201; G06Q 50/22

(57) ABSTRACT

A computerized system and method for measuring and analyzing provider utilization is disclosed. In an example embodiment, a Provider Utilization Management Software Application comprises a data selection component and a presentation model that illustrates how a provider's claim data submitted to a health benefits company compares to providers in the same network, geographic region, or other provider grouping (e.g., by state, zip code, MSA, provider specialty type, or in-plan status). This utilization data may be used to identify problem providers that have high, low, or unusual utilization patterns. Various measures may be calculated and analyzed. Results of the analysis may be presented in various reports. Once problem providers are identified, they may be monitored. In some instances, one or more corrective actions may be taken.

### CROSS-REFERENCE TO RELATED APPLICATIONS

None.

### BACKGROUND

Health benefits companies typically rely on third-party healthcare providers to provide healthcare services to the members of their plans. Many health benefit companies establish and maintain extensive networks of providers that offer various types of healthcare services to meet the diverse healthcare needs of their plan members. In addition to ensuring the network has providers that can cover basic as well as specialized needs of the members, it is also important for the health benefits company to have a sufficient number of providers in each area to support the member population. As a result, it is important for a health benefits company to review its provider networks to be sure they are adequate in multiple dimensions. Health benefits companies may also rely on third-party healthcare providers that members select for themselves and that are not part of a service network.

Each healthcare provider, whether in- or out- of network, typically provides services to health benefit plan members according to the terms and conditions of a contract with the health benefits company. The healthcare provider is reimbursed for services according to the terms and conditions of the contract. In most instances, the healthcare provider is reimbursed in connection with claims for payment that are submitted to the health benefits company. After meeting with a plan member for a consultation or service, the healthcare provider submits to the health benefits company a claim requesting a payment for the specific service. The health benefits company adjudicates the claim to determine a level of payment to the provider pursuant to the provider's contract and the member's plan and then remits a payment to the provider according to the adjudicated claim.

For healthcare providers that provide the same or similar services, it is reasonably expected member utilization of the provider's services over a period of time will be similar. Variations in utilization for providers offering similar services to a group of members may signal differences in the level of service and treatment offered by the providers. The differences may be warranted for a variety of reasons or they may indicate that a provider is not adhering to well-established practice standards or other appropriate criteria. For providers with utilization rates that lie outside expected rates, it is important for the health benefits company to understand the reasons for the variations. Measuring and analyzing provider utilization, therefore, is an important aspect of provider management. Another important aspect of provider management is managing overall plan costs, including those claims from out-of-network providers.

For health benefit companies that develop and maintain a large number of provider networks or that receive claims from a large number of providers, collecting the data that is needed to measure provider utilization and completing the utilization analysis requires a substantial undertaking. Utilization may be measured by analyzing member claim data but large health benefits companies process and store such a considerable amount of claim data, it cannot be analyzed manually. Furthermore, results are typically easier to review and understand using computer-generated graphs and charts. Therefore, there is a need for a computerized system and method for measuring and analyzing provider utilization. There is further a need for a computerized system and method for comparing provider utilization data to identify providers with utilization rates that are outside an expected value or range. Finally, there is a need a computerized system and method that supports the generation and presentation of provider utilization data to assist providers in understanding and improving their utilization rates.

### SUMMARY

The present disclosure is directed to a computerized system and method for measuring and analyzing provider utilization. In an example embodiment, a Utilization Management Software Application comprises a data selection component and a presentation model that illustrates how a provider's claim data submitted to a health benefits company compares to providers in the same network, geographic region, or other provider grouping (e.g., by state, zip code, MSA, provider specialty type, or in-plan status). This utilization data may be used to identify problem providers that have high, low, or unusual utilization patterns. Once problem providers are identified, they may be monitored. In some instances, one or more corrective actions may be taken such as:

TABLE 1
Utilization Issues and Actions

| | |
|---|---|
| Excessive Utilization | Flag for additional services may lead to claim |
| Rate | savings and behavior changes. |
| Fee Schedule/ | Provide discount comparison and utilization |
| Charge/Utilization | information to the actuarial team to determine if |
| Comparison | Humana should try to negotiate a new and |
| | better fee schedule. Provide utilization patterns |
| | and average charge amounts to determine |
| | network recruitment viability for an out of |
| | network provider. |
| Potential Fraud Pattern | Direct providers with potentially fraudulent |
| | claims to a Special Investigations Unit |
| Region to Nation | Evaluate plan variations by market to determine |
| Utilization | if plan design is a driver for high utilization |
| Comparisons | |
| Analyze Utilization | Identify problems with standard plans |
| Rates for Standard | |
| Plans | |

### BRIEF DESCRIPTION OF THE DRAWINGS

FIG. 1 is a screen for retrieving dental provider data according to an example embodiment;

FIG. 2.0A-2.5 are a sample high level comparison report according to an example embodiment;

FIG. 3-3.1 are a sample utilization comparison report according to an example embodiment;

FIG. 4-4.1 are a sample discount comparison report according to an example embodiment;

FIG. 5-5.1 are a sample charge comparison report according to an example embodiment;

FIG. 6A-6.4 are a sample drill down comparison report according to an example embodiment;

FIG. 7-7.1 are a sample drill down utilization comparison report according to an example embodiment; and

FIGS. 8-8.2 and 9A-9B are sample provider distribution by utilization ratios reports according to an example embodiment.

### DETAILED DESCRIPTION

In an example embodiment, claim data for one or more dental providers is retrieved from a SQL Server database. Search criteria may include provider identifying data such as an assigned provider number or a provider's name, address, zip code, etc. The extracted data is then populated in a graphing and charting application such as Microsoft® Excel. In an example embodiment, the utilization analysis is focused in 12 primary comparisons of services that are commonly over-utilized. These comparisons show utilization data for one type of procedure in relation to another. In an example embodiment, the 12 comparisons are:

TABLE 2
Utilization Comparisons

| | |
|---|---|
| Ratio of | All the providers are ranked based on this ratio and |
| utilization | where they compare against their peers. Providers |
| percentage of | with ranks close to 5 are high utilizers and providers |
| surgical | with a rank close to 1 are low utilizers, when compared |
| extractions | to their peers. The nationwide ratio is also used as a |
| | comparison. |
| Deal Strength | For in network providers, a provider's average charge |
| | and average allowed amount (i.e., fee schedule) is |
| | determined. Then, an overall average charge is |
| | calculated for all the providers in the data set, and the |
| | allowed amount is compared to this average charge to |
| | determine deal strength. This ensures that all |
| | providers' allowed amounts are compared to the same |
| | average. The actual discount percentage may not be |
| | exact, but the provider's relation to other providers in |
| | the same region will show deal strength. |
| Average | A provider's average charge is compared to the |
| Charge | regional average charge. May be used to identify |
| | potential providers. For example, if the provider's |
| | average charge is very high, the provider may not be |
| | an ideal candidate for the network because a large |
| | discount would be needed to get reasonable contracted |
| | fees. |

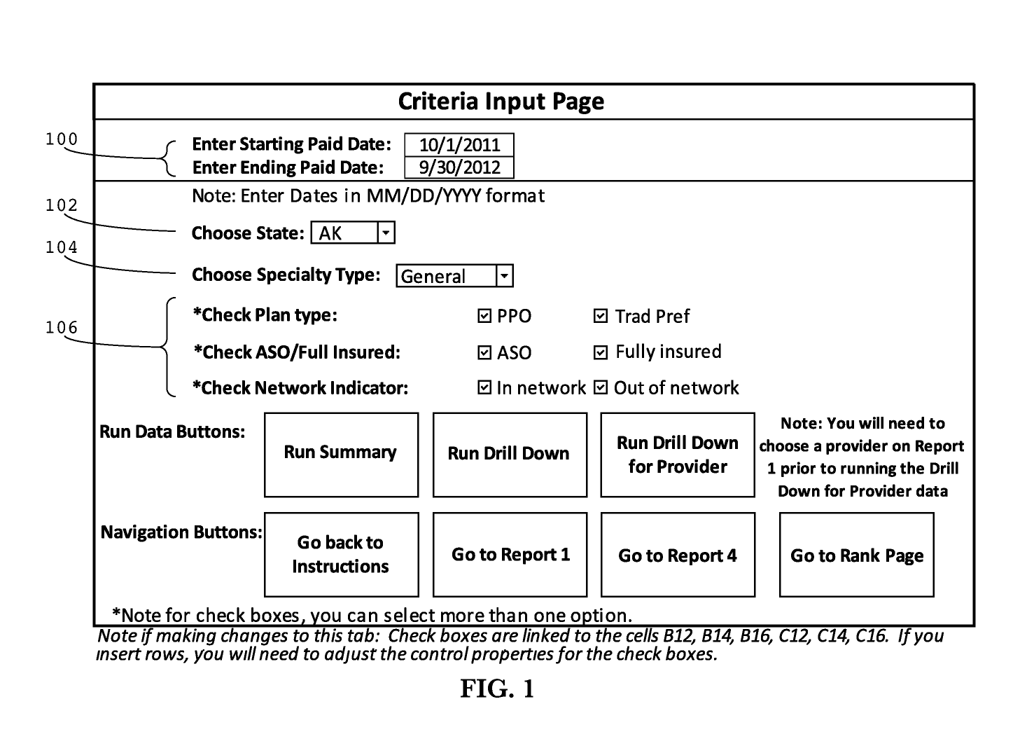

Referring to FIG. 1, a screen for retrieving dental provider data according to an example embodiment is shown. In an example embodiment, a user may enter claim paid start and end dates 100. Other search parameters include the providers state 102, specialty type 104 (e.g., general dentist, endodontist, oral surgeon, periodontist, prosthodontist, and pediatric dentist), health benefit plan type and related data 106. Data meeting the search parameters is retrieved from a database to facilitate comparisons between a specific provider and other providers in the data sample.

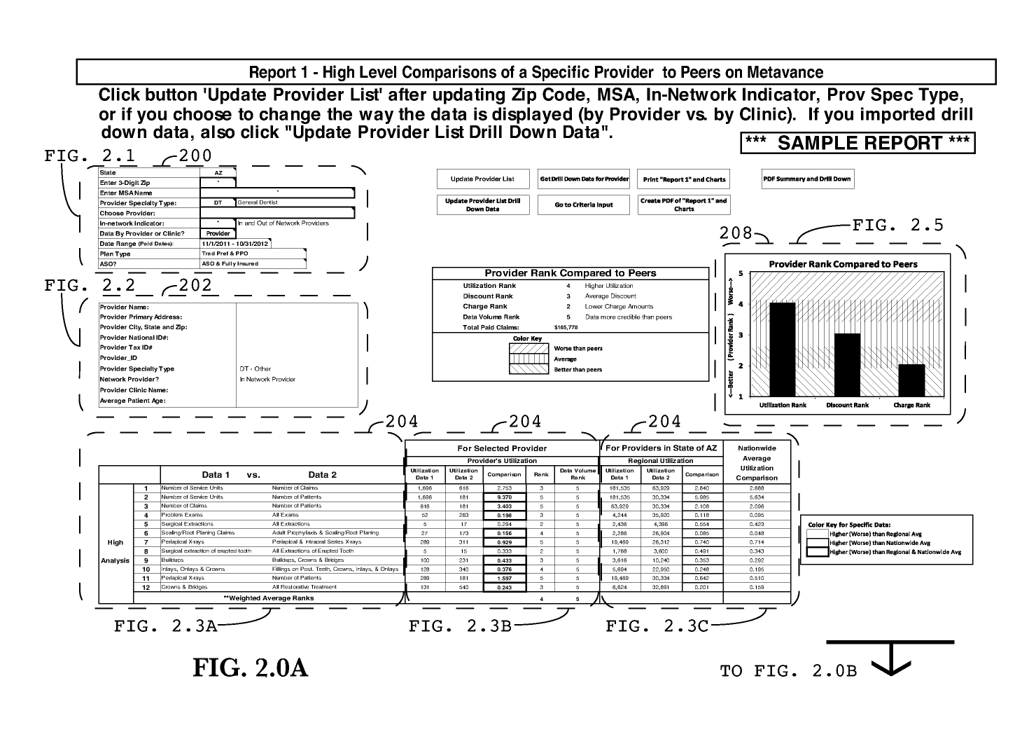

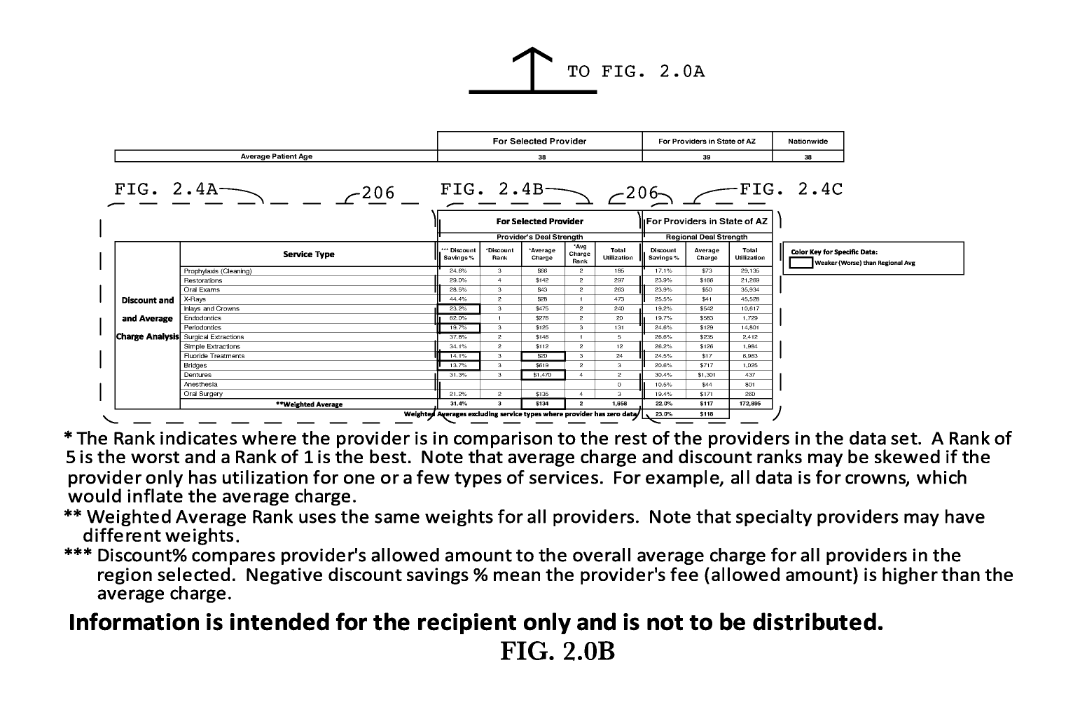

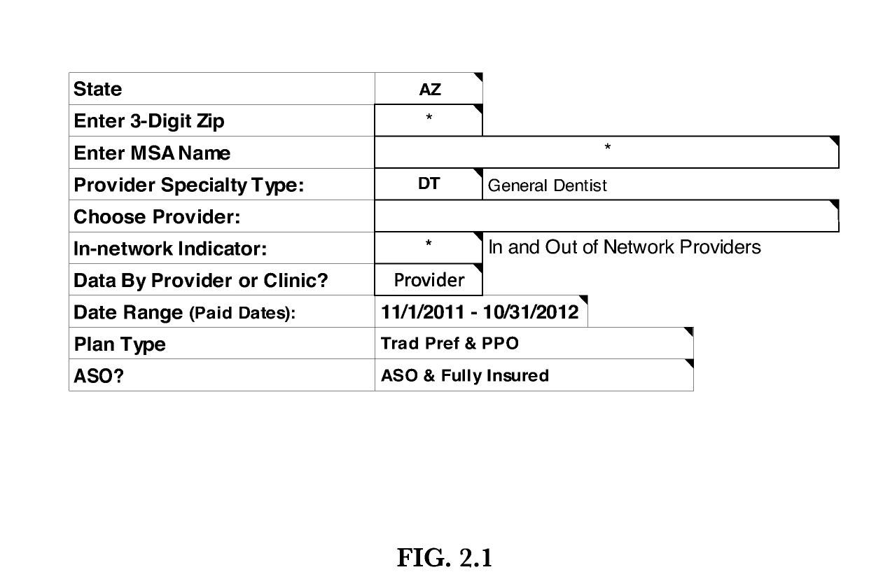

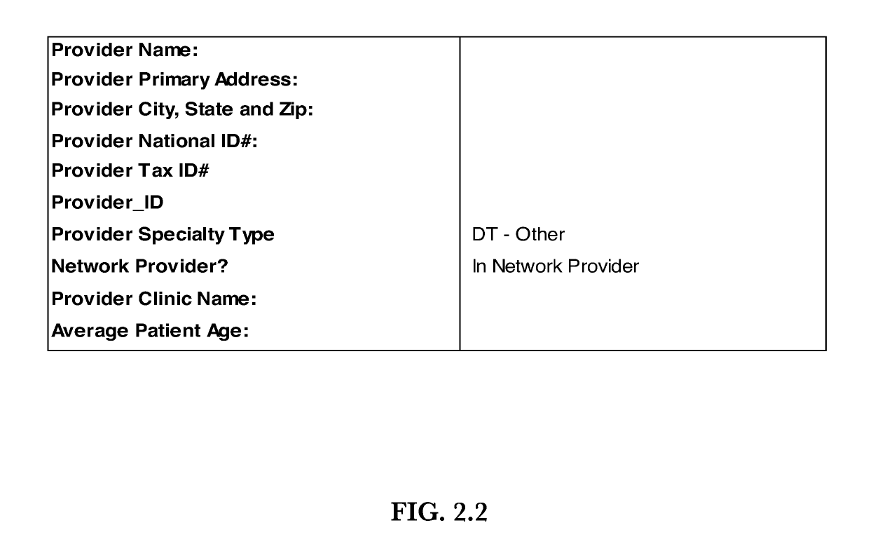

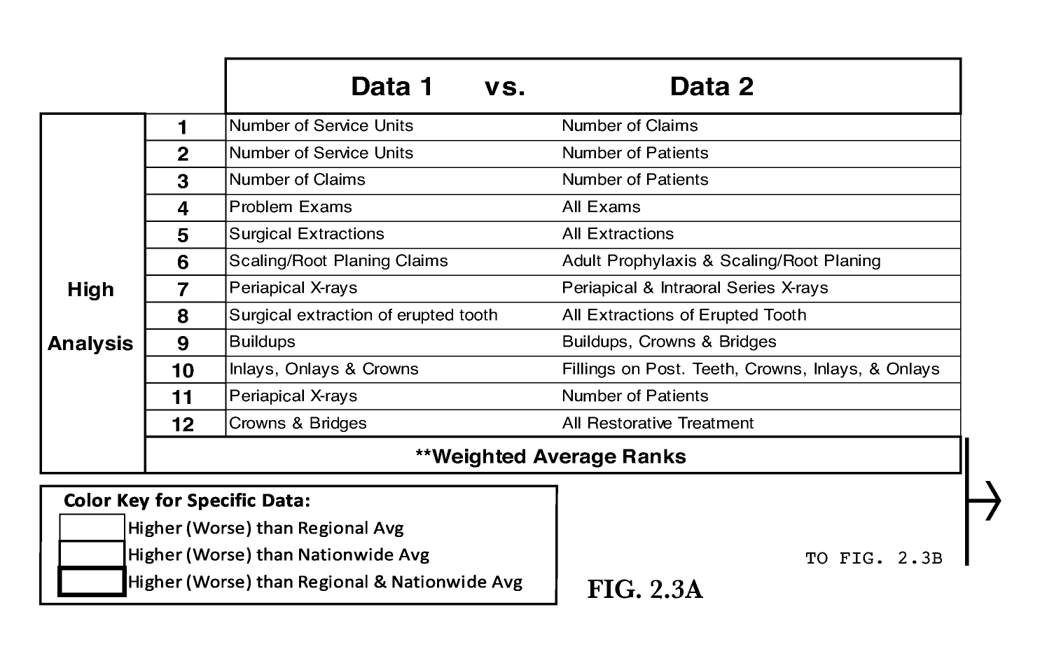

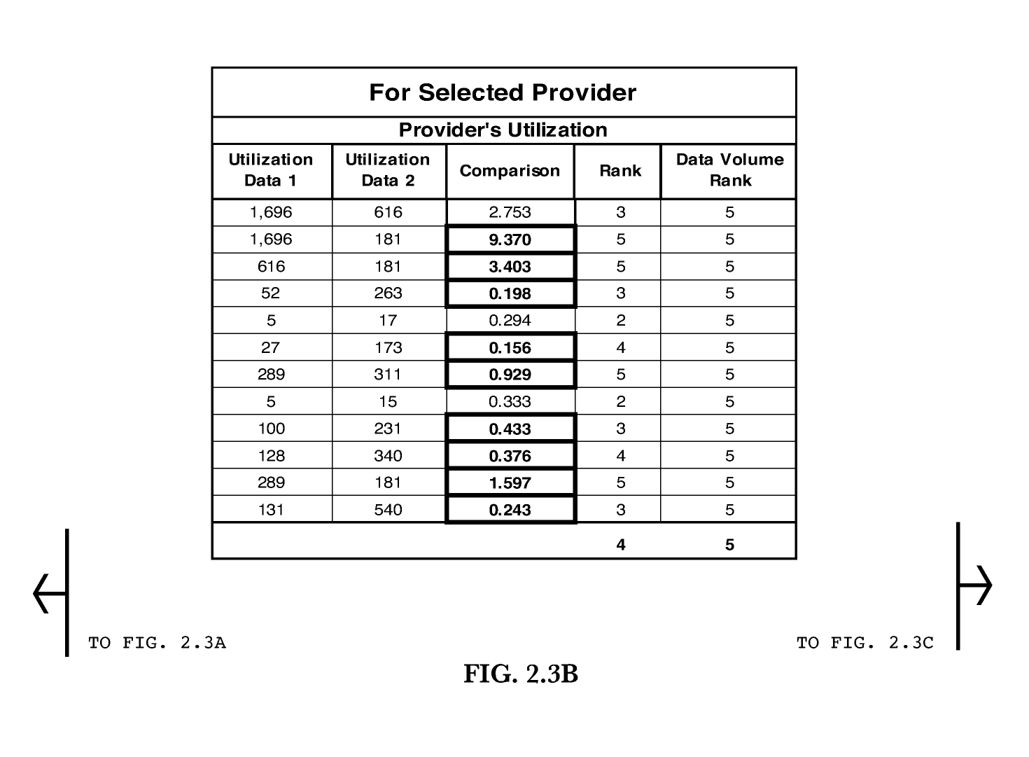

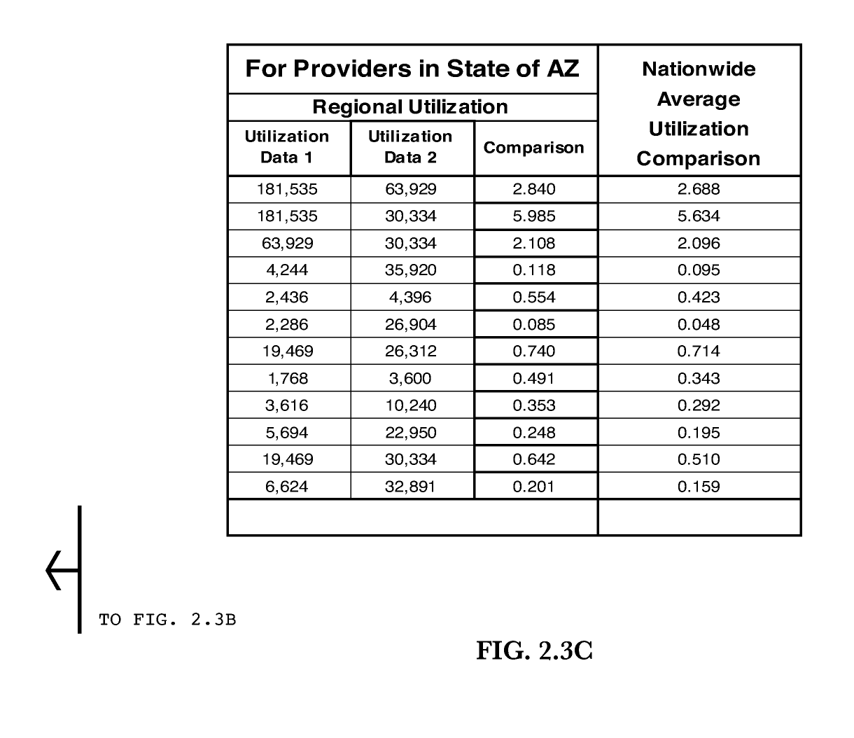

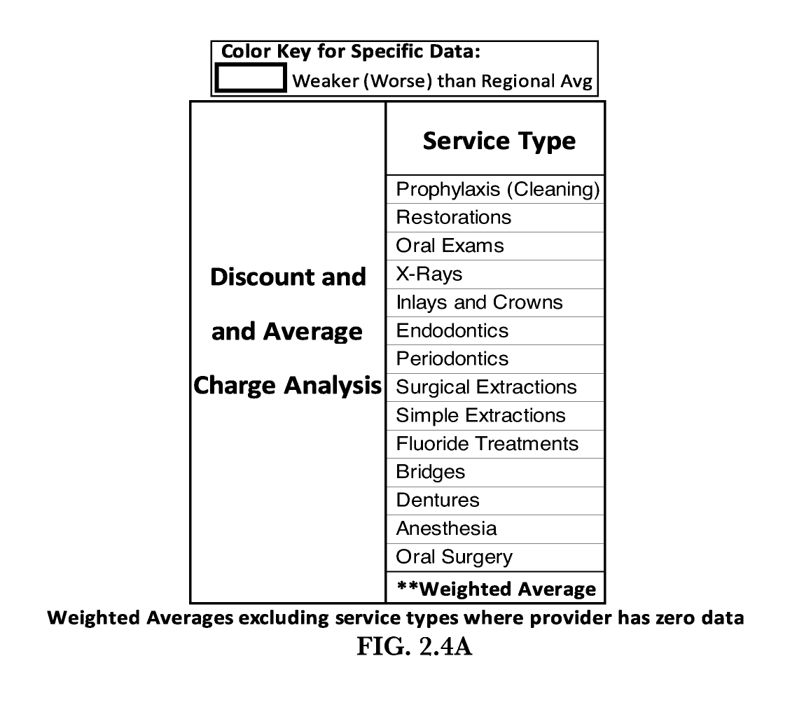

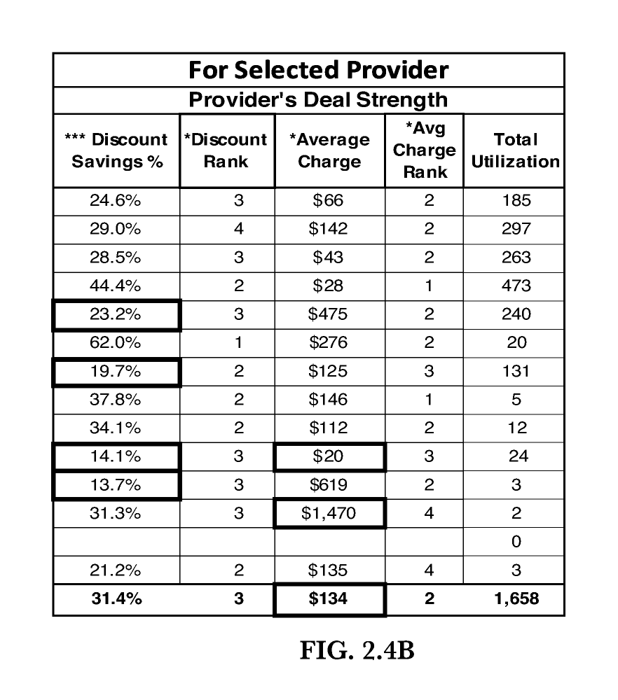

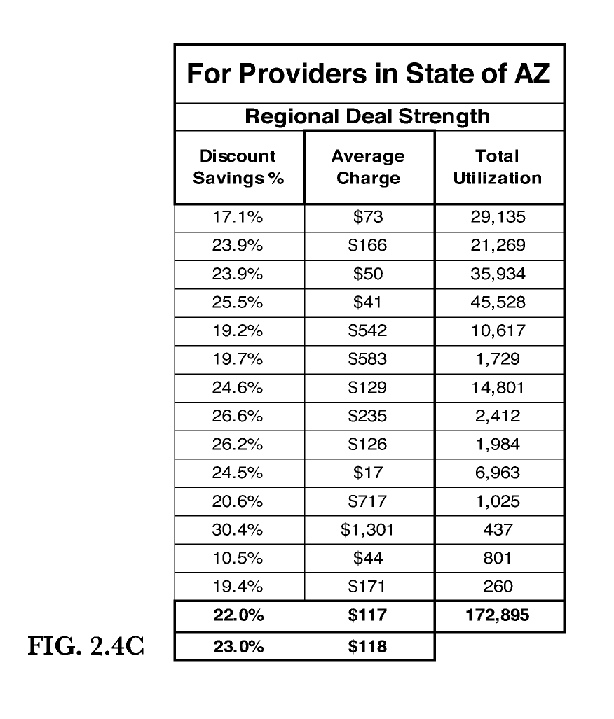

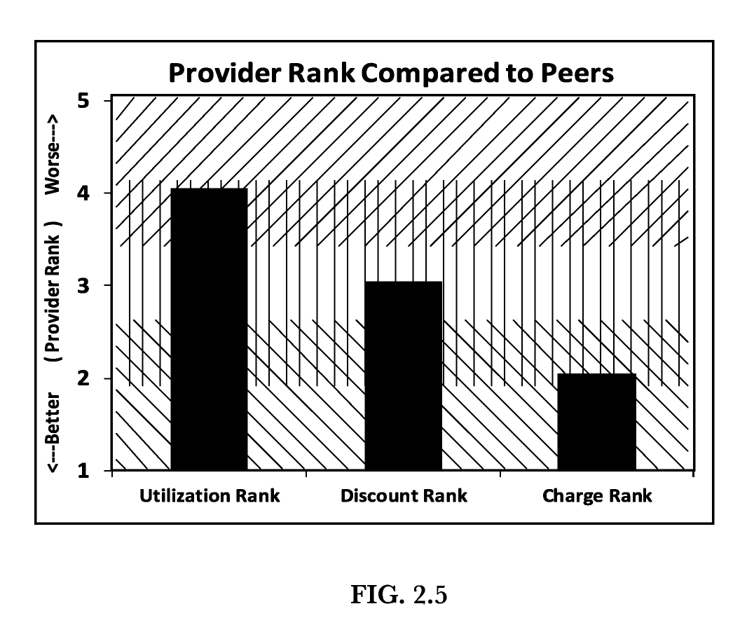

Referring to FIGS. 2.0A-2.5, a sample high level comparison report according to an example embodiment is shown. The report comprises a section listing the search parameters 200 as well as identifying data for the specific provider for which the data comparisons are provided 202. In another section, weighted average ranks in multiple areas are listed 204. In this section, data for the provider's utilization and the regional utilization is presented. Nationwide averages are also shown.

In an example embodiment, the utilization parameters and key comparisons include:

TABLE 3
Comparisons

| | |
|---|---|
| Number of Service Units | Number of Claims |
| Number of Service Units | Number of Patients |
| Number of Claims | Number of Patients |
| Problem Exams | All Exams |
| Surgical Extractions | All Extractions |
| Scaling/Root Planing Claims | Adult Prophylaxis and Scaling/Root |
| | Planing |
| Periapical X-rays | Periapical, Panoramic X-rays and |
| | Intraoral Series X-rays |
| Surgical Extraction of Erupted | All Extractions of Erupted Tooth |
| Tooth | |
| Buildups | Buildups, Crowns, and Bridges |
| Inlays, Onlays and Crowns | Fillings on Posterior Teeth, Crowns, |
| | Inlays and Onlays |
| Periapical X-rays | Number of Patients |
| Crowns and Bridges | All Restorative Treatment |

In yet another section, the utilization parameter or parameters relate to service types and service type comparisons are shown. In this section, data for the provider's deal strength and the regional deal strength is shown. The deal strength provides an indication of the provider's charges for various services in relation to other providers in the region.

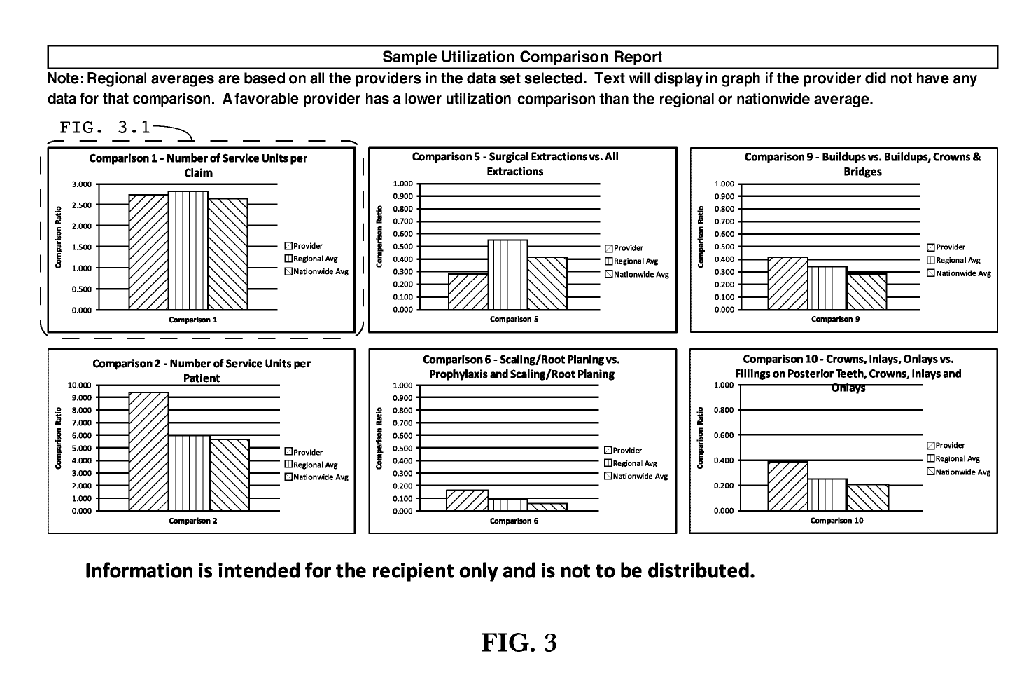

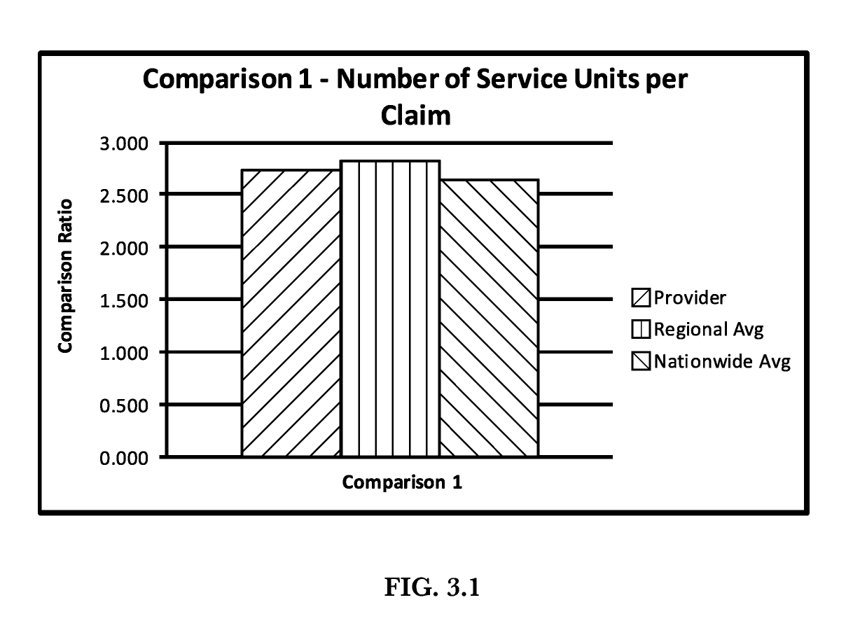

Referring to FIGS. 3-3.1, a sample utilization comparison report according to an example embodiment is shown. In the sample comparison report, provider, regional average, and national average comparison rates for a plurality of dental services are shown. The comparisons may be used to provide feedback to a specific provider regarding the services he or she provides compared to peers.

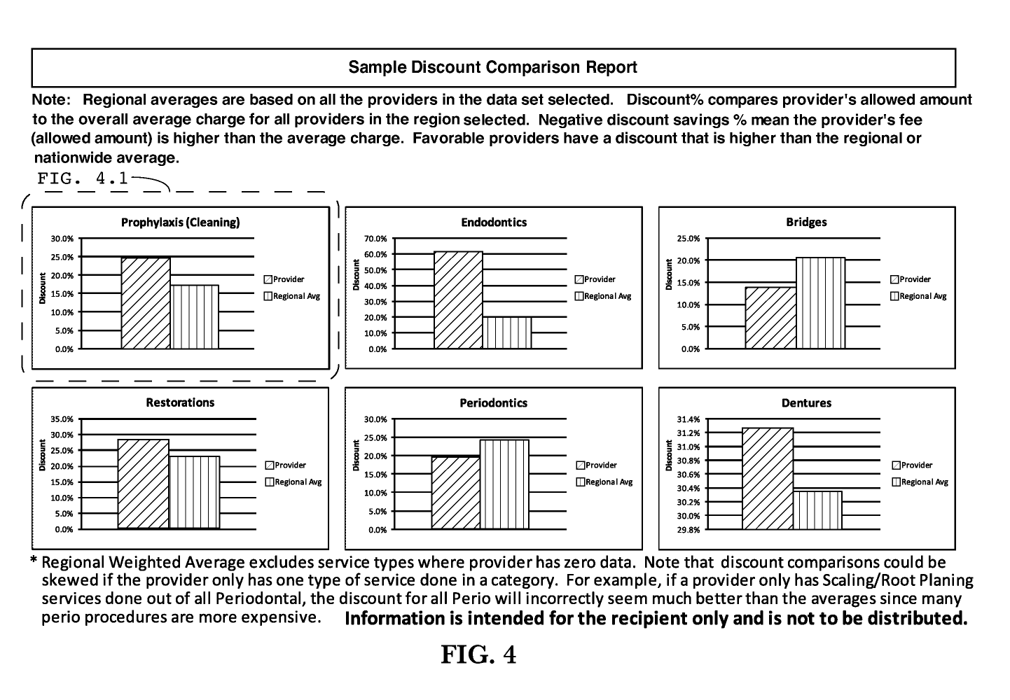

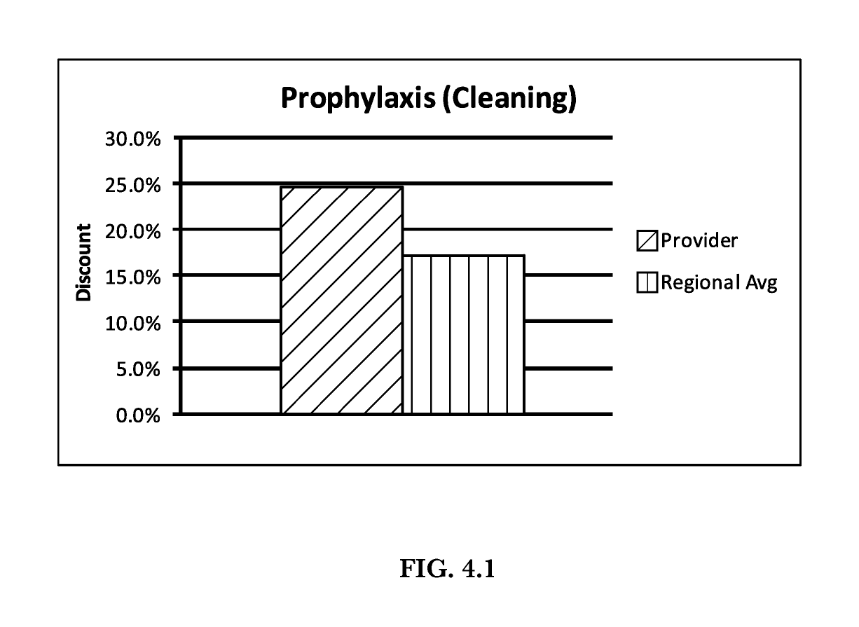

Referring FIGS. 4-4.1, a sample discount comparison report according to an example embodiment is shown. In the sample comparison report, the provider's discount rates for various dental services are compared to regional average rates.

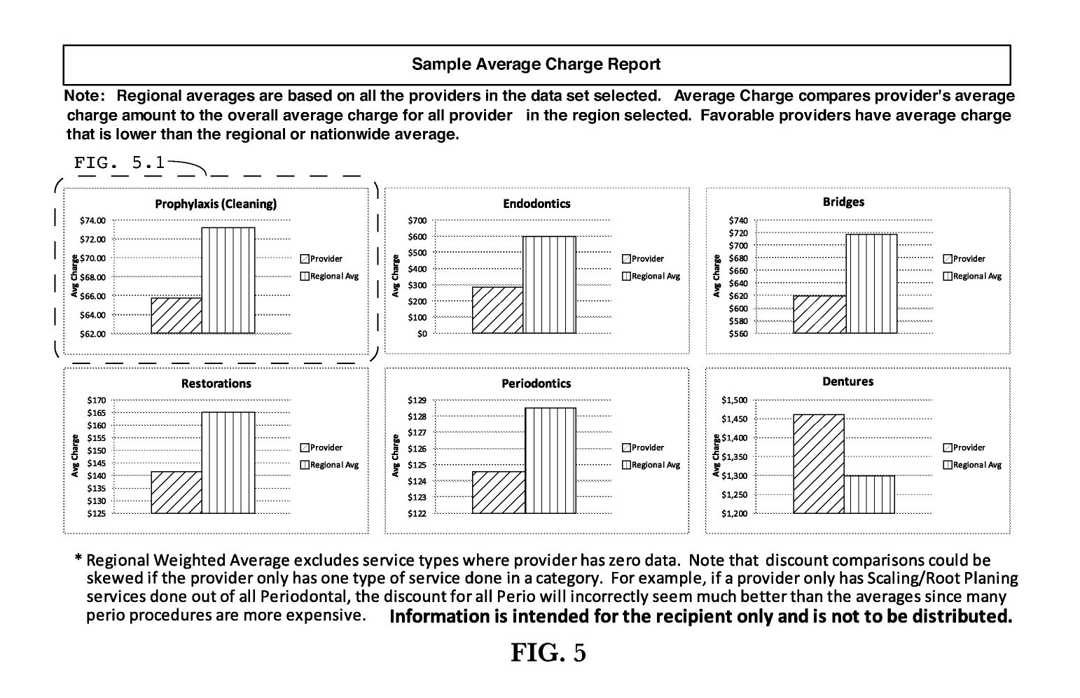

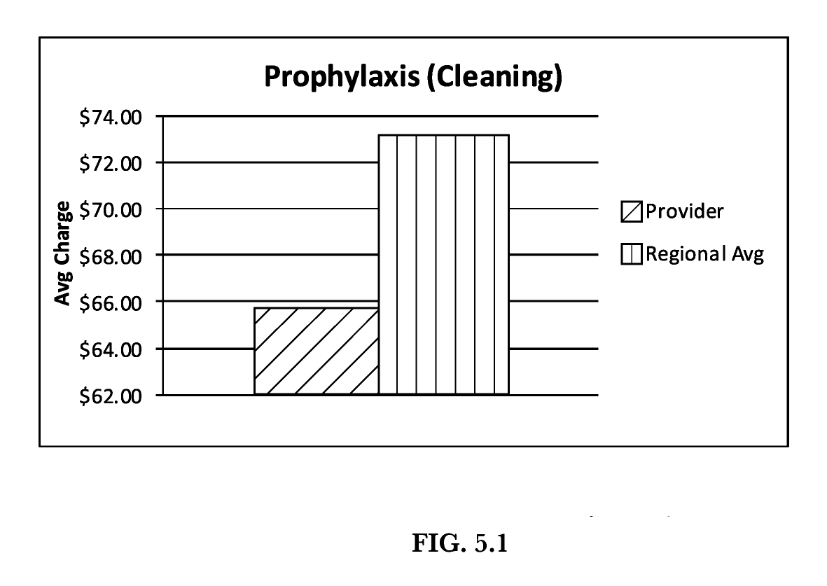

Referring to FIGS. 5-5.1, a sample charge comparison report according to an example embodiment is shown. In the sample comparison report, the provider's average charge for various dental services are compared to regional average charges.

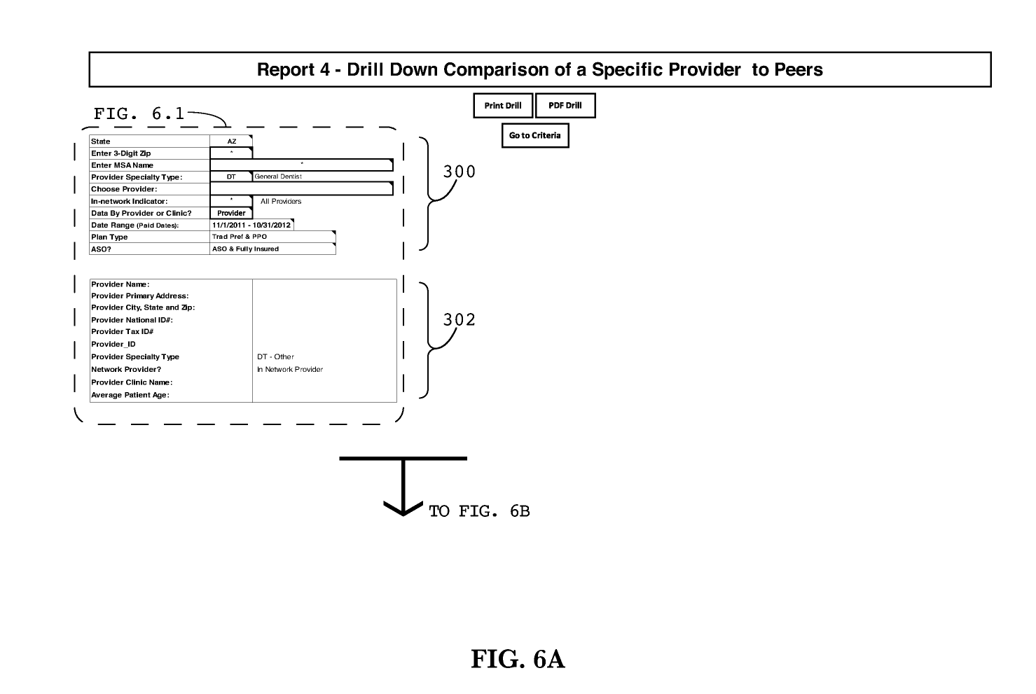

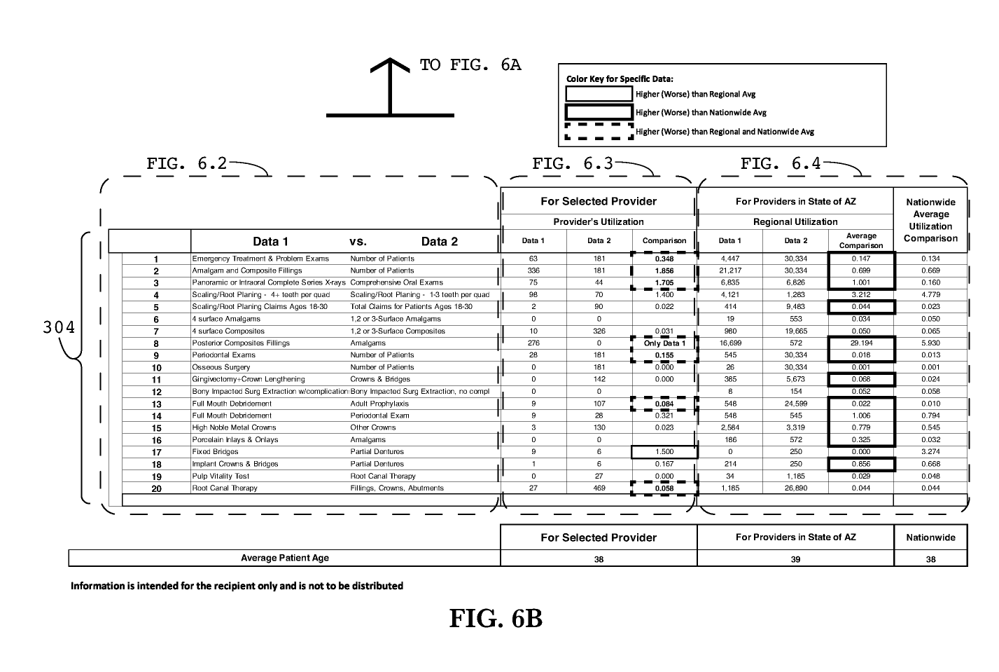

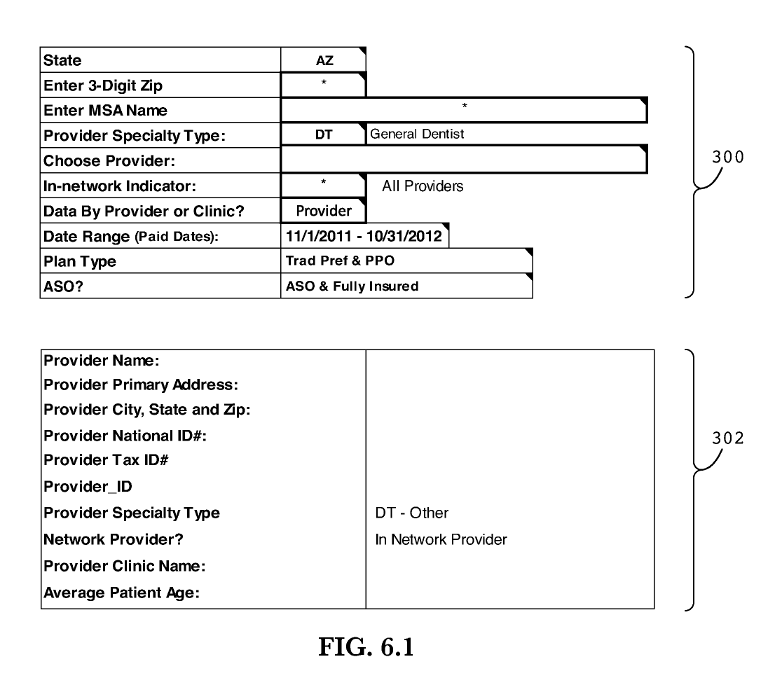

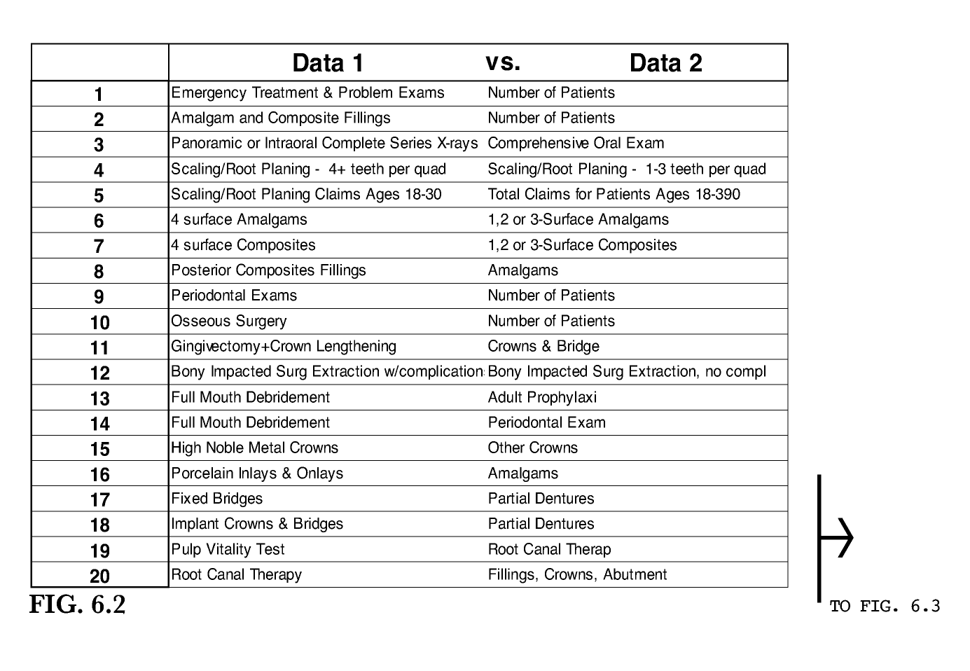

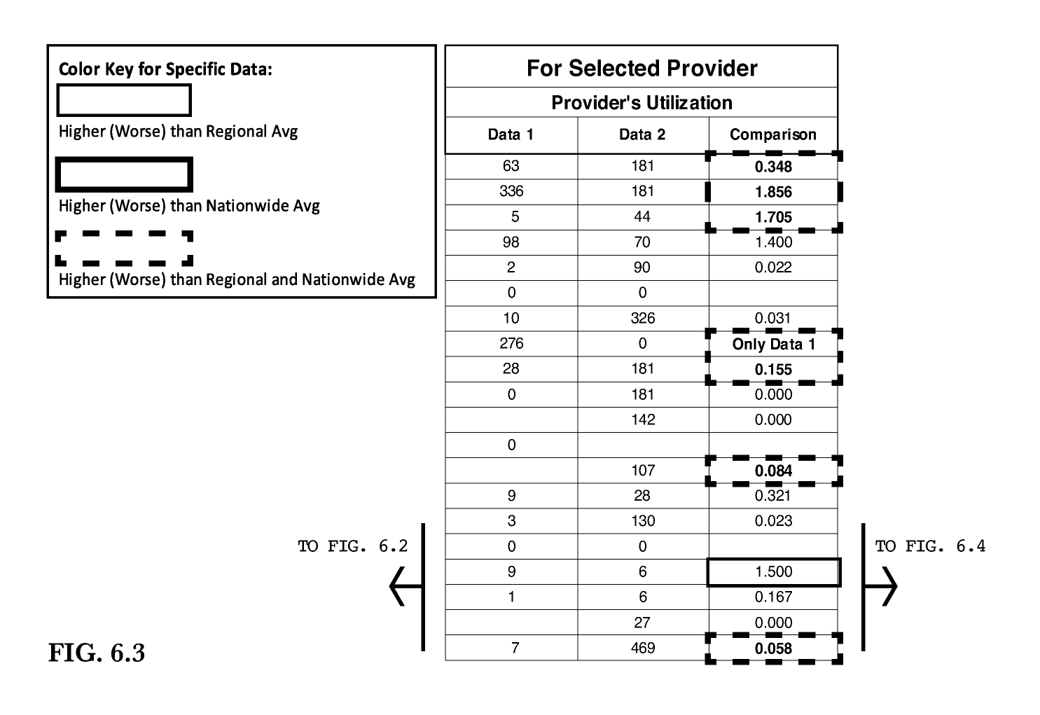

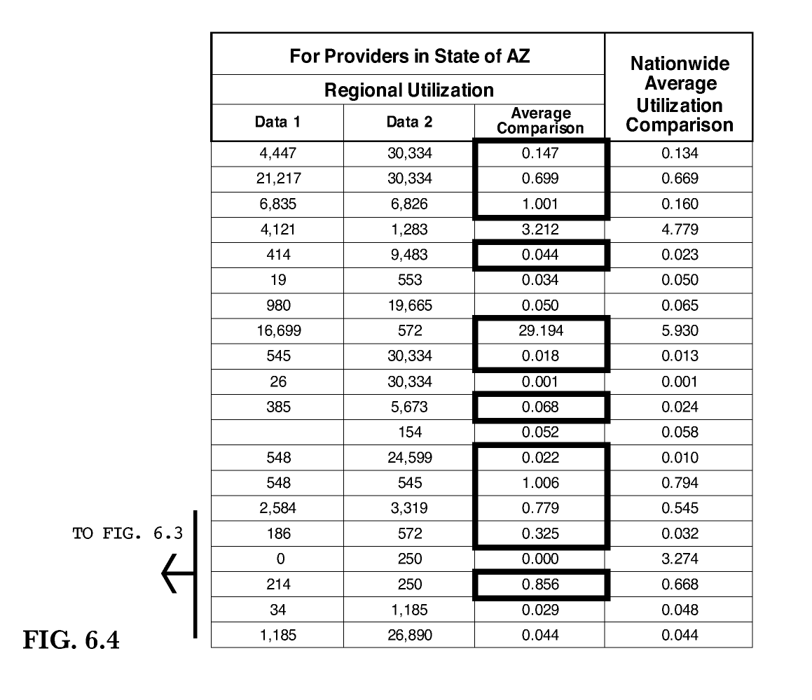

Referring to FIGS. 6A-6.4, a sample drill down comparison report according to an example embodiment is shown. In an example embodiment, the report comprises a search criteria section 300 listing search criteria used in selecting regional provider data for the comparisons. The report further comprises a provider section listing provider identifying data 302. Finally, the report comprises a data comparison section 304 listing a plurality of data comparisons between the specified provider and other regional providers. In an example embodiment, ratios for various utilization measures are calculated. The provider's ratios are then compared to regional provider average ratios as well as nationwide average ratios.

In an example embodiment, the utilization ratios include the following:

TABLE 4
Utilization Ratios

| | |
|---|---|
| Emergency Treatment and Problem | Number of Patients |
| Exams | |
| Amalgam and Composite Fillings | Number of Patients |
| Panoramic or Intraoral Complete Series X- | Comprehensive Oral Exams |
| rays | |
| Scaling/Root Planing - 4+ teeth per quad | Scaling/Root Planing - |
| | 1-3 teeth per quad |
| Scaling/Root Planing Claims 18-30 | Total Claims for Patients |
| | 18-30 |
| 4 Surface Amalgams | 1, 2, or 3 Surface Amalgams |
| 4 Surface Composites | 1, 2, or 3 Surface Amalgams |
| Posterior Composite Fillings | Amalgams |
| Periodontal Exams | Number of Patients |
| Osseous Surgery | Number of Patients |
| Gingivectomy and Crown Lengthening | Crowns and Bridges |
| Bony Impacted Surgical Extraction | Bony Impacted Surgical |
| without Complications | Extraction without |
| | Complications |
| Full Mouth Debridement | Adult Prophylaxis |
| Full Mouth Debridement | Periodontal Exam |
| High Noble Metal Crowns | Other Crowns |
| Porcelain Inlays and Onlays | Amalgams |
| Fixed Bridges | Partial Dentures |
| Implant Crowns and Bridges | Partial Dentures |
| Pulp Vitality Test | Root Canal Therapy |
| Root Canal Therapy | Fillings, Crowns, Abutments |

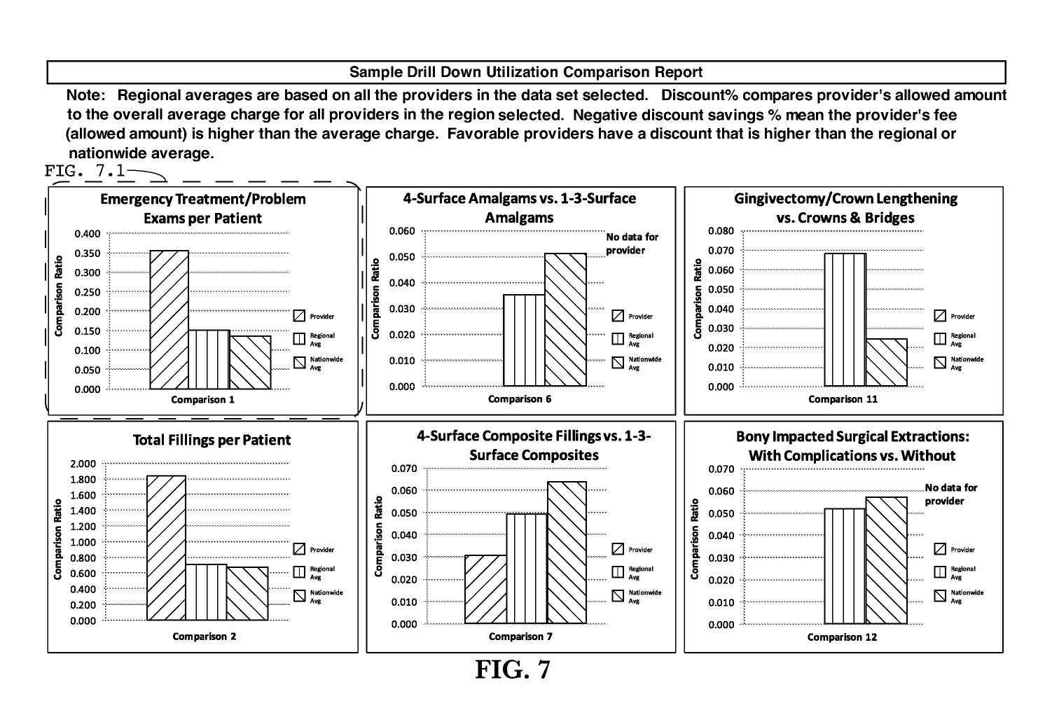

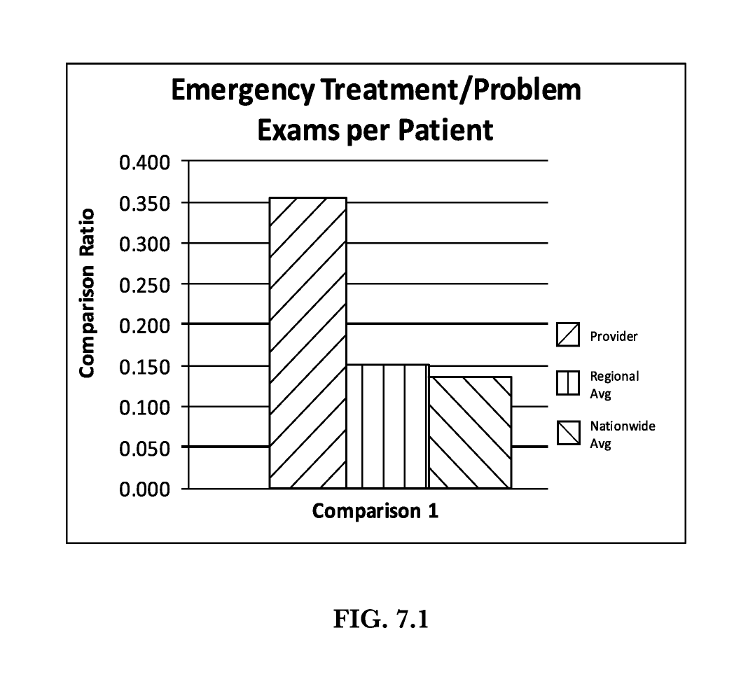

Referring to FIGS. 7-7.1, a sample drill down utilization comparison report according to an example embodiment is shown. In the sample comparison report, the provider's utilization ratios for various dental services are compared to regional average ratios as well as nationwide average ratios.

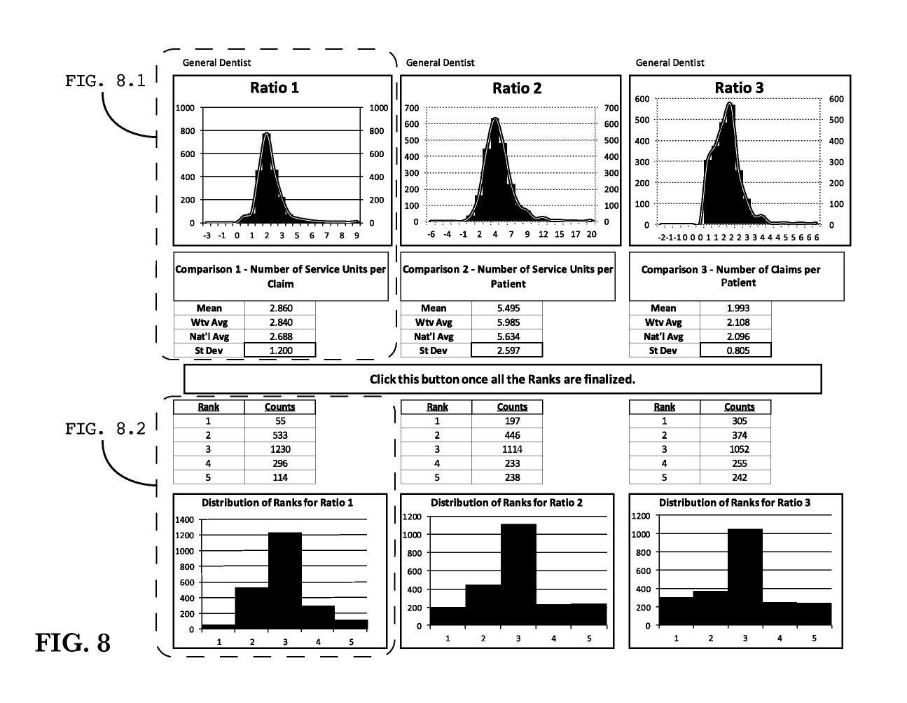

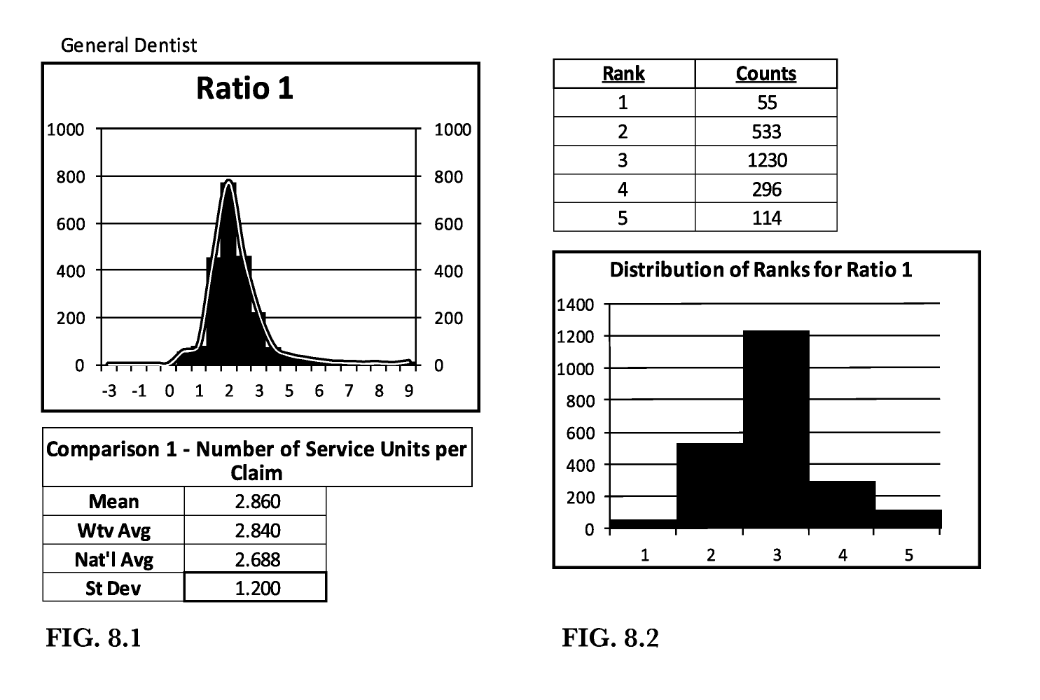

Referring to FIGS. 8-8.2 and 9A-9B, sample provider distribution by utilization ratios reports according to an example embodiment are shown. Referring to FIG. 8, the report shows the distribution of providers by utilization ratios on the prior data. Based on the average and the distribution of providers, a rank is assigned to each ratio. This rank is then assigned to each provider based on their specific ratio. The model then calculates an overall rank based on pre-set specific weights. Referring to FIG. 9A-9B, a report comprising distribution of ranks for a plurality of ratios is shown.

While certain embodiments of the disclosed computerized system and method for measuring and analyzing provider utilization are described in detail above, the scope of the invention is not to be considered limited by such disclosure, and modifications are possible without departing from the spirit of the invention as evidenced by the claims. For example, other measurements of utilization may be calculated and analyzed and fall within the scope of the claimed invention. Various aspects of data presentation may be varied and fall within the scope of the claimed invention. One skilled in the art would recognize that such modifications are possible without departing from the scope of the claimed invention.

1-13. (canceled)

14. A computerized system for calculating and presenting healthcare provider service utilization data comprising:
(1) a computer-accessible database comprising healthcare claim data for a plurality of healthcare providers; and
(2) a computer executing instructions to:
(a) store in said computer at least one service utilization parameter selected from the group consisting of: number of service units, number of claims, number of patients, and number of procedures;
(b) receive by said computer healthcare provider identifying data for a specific healthcare provider;
(c) receive by said computer healthcare provider search criteria for accessing said healthcare claim data in said computer-accessible database, said provider search criteria including:
(1) identifying data for said healthcare providers; and
(2) start and end dates for healthcare claims;
(d) search by said computer said healthcare claim data in said database to locate healthcare claims matching said:
(1) healthcare provider search criteria; and
(2) said service utilization parameter;
(e) calculate by said computer from said healthcare claims for said plurality of healthcare providers an average service utilization value for said service utilization parameter;
(f) search by said computer said healthcare claim data to locate healthcare claims matching said:
(1) healthcare provider identifying data for a specific healthcare provider; and
(2) said service utilization parameter;
(g) calculate by said computer a provider service utilization value for said specific healthcare provider;
(h) generate by said computer a display comprising a comparison of said provider service utilization value and said average service utilization value; and
(i) calculate a ranking for said specific healthcare provider in relation to said plurality of healthcare providers.

15. (canceled)

16. The computerized system of claim 14 wherein said average service utilization value is a regional average utilization value.

17. The computerized system of claim 14 wherein said average service utilization value is a national average utilization value.

18. The computerized system of claim 14 wherein said provider service utilization value is a ratio.

19. The computerized system of claim 14 wherein said computer further executes instructions to generate a comparison of charges and discounts for said healthcare provider and said plurality of healthcare providers.

20. (canceled)
